(19) United States
(12) Patent Application Publication
(10) Pub. No.: US 2017/0068316 A1
(43) Pub. Date: Mar. 9, 2017

(54) INPUT DEVICE USING EYE-TRACKING

(71) Applicant: VISUALCAMP CO., LTD., Daejeon (KR)

(72) Inventor: Yoon Chan SEOK, Seoul (KR)

(21) Appl. No.: 15/357,184

(22) Filed: Nov. 21, 2016

Related U.S. Application Data
(63) Continuation of application No. PCT/KR2015/001644, filed on Feb. 17, 2015.

(30) Foreign Application Priority Data
May 20, 2014 (KR) 10-2014-0060315
Oct. 23, 2014 (KR) 10-2014-0143985

(51) Int. Cl. G06F 3/01; G06F 3/0488; G06F 3/023

(52) U.S. Cl. CPC G06F 3/013; G06F 3/0237; G06F 3/04886; G06F 2203/04803

(57) ABSTRACT

An eye tracking type input device includes a displayer for displaying an on-screen keyboard, on which a plurality of keys corresponding to inputtable letters or symbols are arranged, through an image output means; an eye tracker for calculating gaze points according to a user's eyes on the on-screen keyboard; and a detector for sensing letters or symbols, which the user desires to input, according to the calculated gaze points.

### CROSS REFERENCE TO RELATED APPLICATIONS AND CLAIM OF PRIORITY

The present application is a continuation application to International Application No. PCT/KR2015/001644 with an International Filing Date of Feb. 17, 2015, which claims the benefit of Korean Patent Application Nos. 10-2014-0060315 filed on May 20, 2014 and 10-2014-0143985 filed on Oct. 23, 2014 at the Korean Intellectual Property Office, the disclosures of which are incorporated by reference herein in their entirety.

### BACKGROUND

1. Technical Field

Embodiments of the present invention relate to a technology for an input device using a user's eyes.

2. Background Art

Eye tracking is a technology for tracking a location of a user's eyes by sensing movement of the eyeballs of the user. Such technology may be realized using an image analysis method, a contact lens application method, a sensor attachment method, etc. The image analysis method is characterized by detecting movement of the pupils through analysis of images captured by a camera in real time and calculating the directions of eyes with respect to fixed positions reflected in corneas. The contact lens application method uses light reflected in contact lenses equipped with mirrors, a magnetic field of contact lenses equipped with coils, or the like. The contact lens application method is not convenient, but provides high accuracy. The sensor attachment method is characterized by attaching sensors near eyes to detect movement of the eyeballs using change in an electric field according to movement of the eyes. In the case of the sensor attachment method, movement of the eyeballs may be detected even when eyes are closed (when sleeping, etc.).

Recently, the range of device types to which such eye tracking technology is applied is increasing and development of technology for accurately detecting eyes is continuing. Accordingly, an attempt to apply the eye tracking technology to typing of characters has also been made. However, a conventional technology for typing characters through eye tracking has limitations in terms of accuracy and speed.

### SUMMARY

Embodiments of the present invention are intended to provide an input means for inputting characters, symbols, or the like through tracking of a user's eyes.

In accordance with an aspect of the present invention, provided is an input device using eye tracking, including: a displayer configured to display an on-screen keyboard, on which a plurality of keys corresponding to inputtable letters or symbols are arranged, through an image output means; an eye tracker configured to calculate gaze points on the on-screen keyboard according to a user's eyes; and a detector configured to detect letters or symbols, which the user desires to input, according to the calculated gaze points.

The displayer may arrange the keys in the on-screen keyboard such that, with increasing use frequency of each of the letters or the symbols, a size of a key corresponding to the letter or the symbol increases.

The displayer may arrange the keys in the on-screen keyboard such that, with increasing use frequency of each of the letters or the symbols, a key corresponding to the letter or the symbol is arranged nearer to a middle of a screen of the image output means.

The on-screen keyboard may include a key for repeatedly inputting a letter or symbol that was input immediately beforehand.

The eye tracker may repeatedly calculate gaze points of the user according to a previously set period.

The detector may construct an eye movement route of the user using the gaze points and, when a fold having a previously set angle or more is present on the eye movement route, determines a key, which corresponds to coordinates at which the fold occurs, as a letter or symbol which the user desires to input.

The eye tracker may detect a change in sizes of the user's pupils on the on-screen keyboard and the detector may determine a key, which corresponds to coordinates at which the change in the sizes of the pupils is a previously set degree or more, as a letter or symbol which the user desires to input.

The eye tracking type input device may further include a word recommender for estimating a word, which the user desires to input, from letters or symbols detected by the detector and displays the estimated word as a recommendation word through the image output means.

The word recommendation unit may compare the letters or symbols detected by the detector to a stored word list and display one or more words selected according to ranking of similarity obtained by the comparison as recommendation words.

The word recommender may estimate a word, which the user desires to input, in consideration of letters or symbols detected by the detector along with letters or symbols closely arranged on the on-screen keyboard.

The eye tracking type input device may further include a word recommender for storing a word list that includes a plurality of words and a standard eye movement route for each of the words, comparing a user's eye movement route calculated from the gaze points calculated by the eye tracker to the word standard eye movement route, and displaying one or more words as recommendation words on the screen according to a route similarity obtained by the comparison.

In accordance with embodiments of the present invention, letters or symbols may be input by sensing user's eyes and using the same. Accordingly, typing may be effectively performed in an environment in which it is difficult to use a physical keyboard.

### BRIEF DESCRIPTION OF THE DRAWINGS

FIG. 1 is a block diagram illustrating the constitution of an eye tracking type input device of according to an embodiment of the present invention.

FIG. 2 is a graph illustrating a use frequency of each alphabet letter in a document in English.

FIG. 3 illustrates a portion of a virtual keyboard according to an embodiment of the present invention.

FIG. 4 illustrates a virtual keyboard according to another embodiment of the present invention.

FIG. 5 illustrates a flowchart for describing a calibration process performed in an eye tracker according to an embodiment of the present invention.

FIG. 6 is an illustration for describing a method of sensing key input in a detector according to an embodiment of the present invention.

### DETAILED DESCRIPTION

Hereinafter, embodiments of the present invention are described with reference to the accompanying drawings. The following description is provided to aid in the comprehensive understanding of methods, devices, and/or systems disclosed in the specification. However, the following description is merely exemplary and not provided to limit the present invention.

In the following description of the present invention, a detailed description of known functions and configurations incorporated herein will be omitted when it would make the subject matter of the present invention unclear. The terms used in the specification are defined in consideration of functions used in the present invention, and can be changed according to the intent or conventionally used methods of clients, operators, and users. Accordingly, definitions of the terms should be understood on the basis of the entire description of the present specification. Terms used in the following description are merely provided to describe embodiments of the present invention and are not intended to be limiting of the inventive concept. As used herein, the singular forms “a,” “an” and “the” are intended to include the plural forms as well, unless the context clearly indicates otherwise. It will be further understood that the terms “comprises” or “has” when used in this specification, specify the presence of stated features, integers, steps, operations, elements, or a portion or combination thereof, but do not preclude the presence or addition of one or more other features, integers, steps, operations, elements, or a portion or combination thereof.

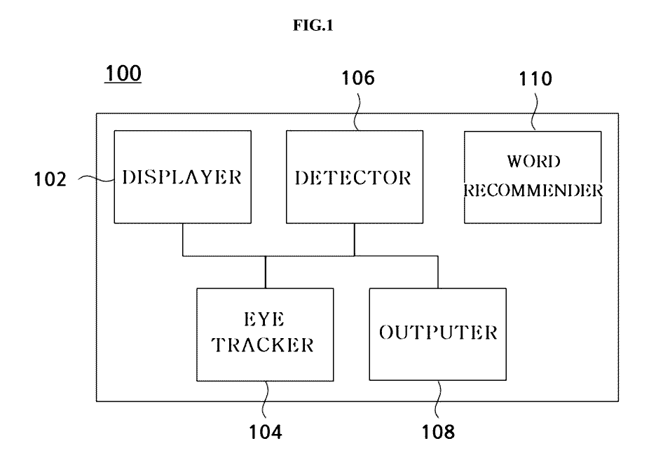

FIG. 1 is a block diagram illustrating the constitution of an input device using eye-tracking 100 of according to an embodiment of the present invention. The input device using eye-tracking 100 according to an embodiment of the present invention refers to a device for tracking movement of a user on a screen and inputting letters or symbols according to the tracked movement. As illustrated in FIG. 1, the eye tracking type input device 100 according to an embodiment of the present invention includes a displayer 102, an eye tracker 104, a detector 106, and an outputer 108. In another embodiment, the input device using eye-tracking 100 may further include a word recommender 110.

The displayer 102 displays an on-screen keyboard, on which a plurality of keys corresponding to inputtable letters or symbols are arranged, through an image output means. In an embodiment, the image output means refers to a device displaying information that may be visually recognized by a user and includes various display devices, such as a monitor, with which a personal computer, a laptop computer, etc. are equipped, a television, a table, and a smartphone.

The on-screen keyboard is a type of virtual keyboard displayed on the image output means. In an embodiment, the on-screen keyboard may have a layout identical or similar to a commonly used QWERTY keyboard or 2-set/3-set Korean keyboard. Since most computer-savvy users are familiar with the arrangement of a general keyboard, a user may type using the on-screen keyboard without a separate adaptation step when the on-screen keyboard is constituted to have a layout similar to a general keyboard.

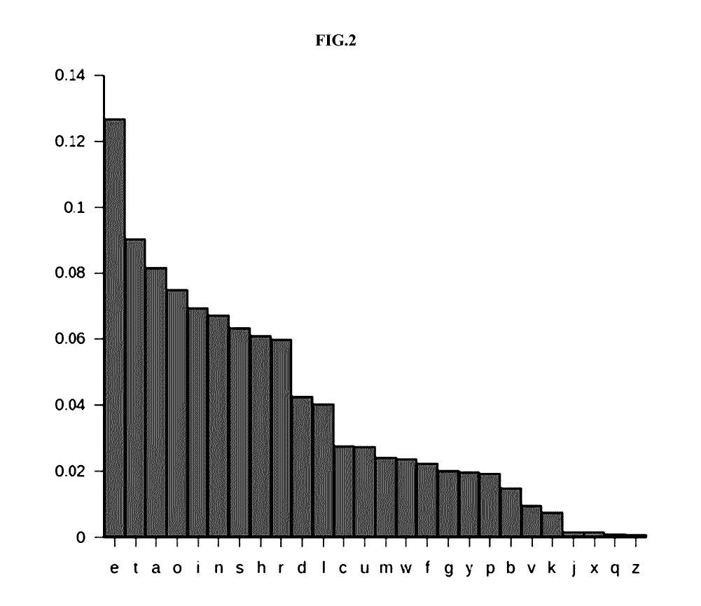

In another embodiment, the displayer 102 may arrange a plurality of keys in the on-screen keyboard such that, with increasing use frequency of each of the letters or symbols, the size of a key corresponding to the letter or symbol increases. This is provided because a use frequency of each of the alphabet letters or phonemes of a specific language is different. FIG. 2 is a graph illustrating a use frequency of each of the alphabet letters investigated by analyzing a document in English. As illustrated in FIG. 2, use frequencies of alphabet letters such as E, T, and the like in language are relatively high, whereas use frequencies of alphabet letters such as X, Q, Z, and the like are very low. Reflecting such statistics, the virtual keyboard may also be constituted such that, with increasing use frequencies of letters or symbols, the sizes of keys corresponding to the letters or the symbols increase.

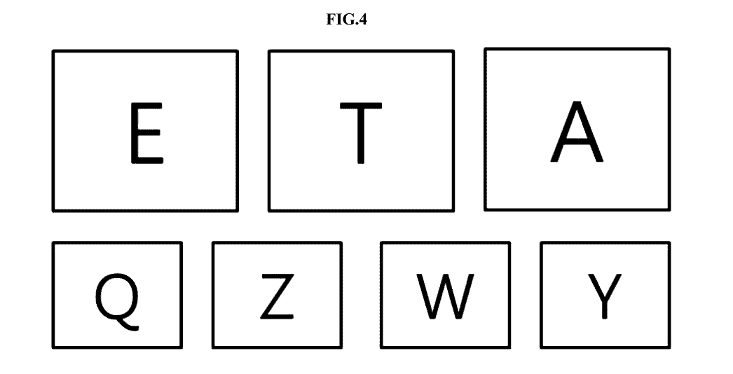

FIG. 4 is an illustration illustrating a portion of a virtual keyboard according to an embodiment of the present invention. As illustrated in FIG. 4, a virtual keyboard according to an embodiment of the present invention may be constituted such that the sizes of keys corresponding to alphabet letters having high use frequencies, such as E, T, and A, in language are relatively large and the sizes of keys corresponding to alphabet letters having low use frequencies, such as Q, Z, W, and Y are relatively small. In the case of a general keyboard configured such that typing is performed by pushing buttons with fingers, input is performed by pushing keys with fingertips of a user. Accordingly, a need to increase the sizes of specific keys according to use frequencies is low. However, in the case of the virtual keyboards according to embodiments of the present invention, when keys are large, the keys may catch the eye of a user and a time for which the user's eyes remain focused thereon also increases. Accordingly, when a virtual keyboard is constituted as described above, typing efficiency may increase.

In another embodiment, the displayer 102 may arrange a plurality of keys in the on-screen keyboard such that, with increasing use frequency of each of the letters or symbols, a key corresponding to the letter or symbol is arranged near the middle of a screen of the image output means. An example thereof is illustrated in FIG. 4.

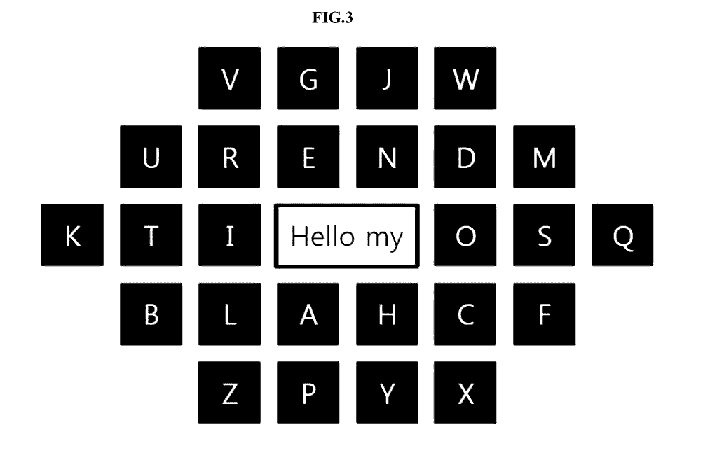

FIG. 3 is an illustration illustrating a virtual keyboard according to another embodiment of the present invention. In the case of the virtual keyboard according to the embodiment, a currently typed sentence is displayed in the middle of a screen and keys, which are designated by alphabet letters, surround the same. As illustrated in FIG. 3, the virtual keyboard may be constituted such that alphabet letters having relatively high use frequencies, such as N, I, and A, are located in the middle of a screen and alphabet letters having relatively low use frequencies, such as W and Q, are located at the edge of the screen. When the virtual keyboard is constituted in this manner, an eye movement distance to input a specific sentence may be shortened. This is possible because frequently used words are concentrated in the middle of the screen.

In addition, the on-screen keyboard may be constituted to include a separate key for repeatedly inputting letters or symbols that were input immediately beforehand. The eye tracking type input device 100 according to an embodiment of the present invention performs typing by sensing eye movement to each key. Accordingly, if the same letter is repeatedly input, processing thereof may be relatively difficult compared to the cases using other input means. Thus, in the case in which the on-screen keyboard includes a separate key for repeatedly inputting keys and a letter or symbol, which was input immediately beforehand, is repeatedly input when eyes are placed on the corresponding key, repeated letters may also be easily recognized.

Meanwhile, although all of the aforementioned embodiments have been described with respect to English letters, the present invention is identically applicable to other languages. That is, it is needless to say that a Korean keyboard may also be constituted such that the size or location of each key is different depending upon the frequency of each phoneme. In addition, the frequency of each of the keys constituting each language may be determined referring to values derived from general documents at the beginning, but, as data input by a user accumulates, the frequency may be adjusted by reflecting the data. For example, when a specific user frequently uses a specific alphabet letter especially, or vice versa, the displayer 102 dynamically changes the layout of the on-screen keyboard by reflecting the same.

Next, the eye tracker 104 calculates gaze points according to the user's eyes on the on-screen keyboard. In particular, the eye tracker 104 may repeatedly calculate gaze points of the user according to a previously set period. For example, the eye tracker 104 may measure gaze points of a user at a time interval of several to several dozen times per second. When the measured gaze points are connected to each other, the route of a user's eyes may be constructed on the on-screen keyboard.

In an embodiment of the present invention, the eye tracker 104 may be constituted to track a user's eyes in various manners and, accordingly, obtain gaze points. As examples of technology for tracking user's eyes, there are three methods, i.e., a video analysis method, a contact lens application method, and a sensor attachment method. Thereamong, the video analysis method is characterized by detecting movement of the eyeballs through analysis of images taken by a camera in real time and calculating the directions of pupils with respect to fixed positions reflected in corneas. The contact lens application method uses light reflected in contact lenses equipped with mirrors, a magnetic field of contact lenses equipped with coils, or the like. The contact lens application method is not convenient, but provides high accuracy. The sensor attachment method is characterized by attaching sensors near eyes to detect movement of the eyeballs to use an electric field dependent upon movement of the eyes. In the case of the sensor attachment method, movement of the eyes may be detected even when the eyes are closed (when sleeping, etc.). However, it should be understood that embodiments of the present invention are not limited to a specific eye tracking method or algorithm.

In addition, the eye tracker 104 may perform, before performing eye tracking, calibration based on data from prior users so as to correct errors according to the characteristics of the eyeballs per user.

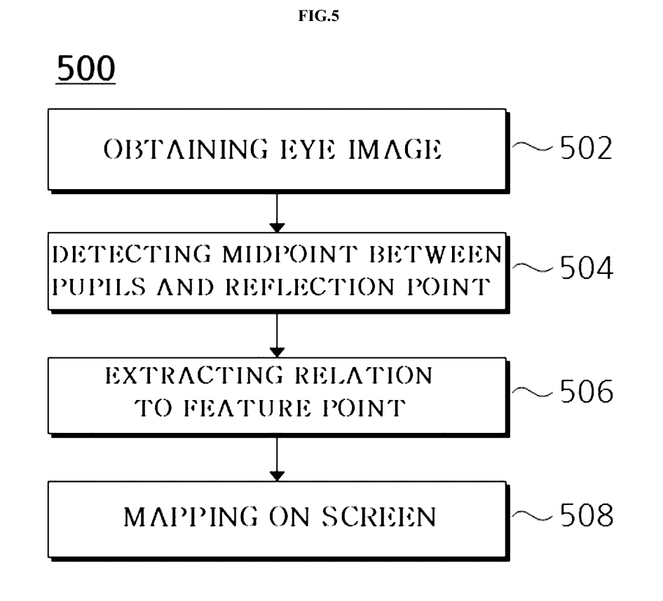

FIG. 5 illustrates a flowchart for describing a calibration process performed in the eye tracker 104 according to an embodiment of the present invention.

In step 502, the eye tracker 104 obtains an eye image of a user through a means such as a camera.

In step 504, the eye tracker 104 detects the midpoint between the pupils and a reflection point from the obtained eye image. The midpoint between the eyeballs and reflection point is used as a default value for measuring subsequent locations of user's eyes.

In step 506, the eye tracker 104 outputs a plurality of feature points on a screen, such that a user stares at the feature points, and calculates a difference between the output feature point and the eyes of the user.

In step 508, the eye tracker 104 completes calibration by mapping the difference calculated in step 506 on a screen.

Next, the detector 106 senses letters or symbols, which the user desires to input, according to the calculated gaze points. Basically, the detector 106 considers a key on an on-screen keyboard, which corresponds to a location on which a user's eyes focus, as a key which a user desires to input. However, since a user's vision is not discontinuous but continuous, the detector 106 may need to include an identification algorithm for determining which parts should be considered as input during movement of the continuous vision.

In an embodiment, the detector 106 may construct a time-dependent eye movement route of a user based on gaze points obtained from the eye tracker 104. The detector 106 determines whether a fold having a previously set angle or more is present on the movement route by analyzing the shape of the eye movement route. When the fold is present, a key corresponding to coordinates at which the bending occurs is considered as a letter or symbol which the user desires to input.

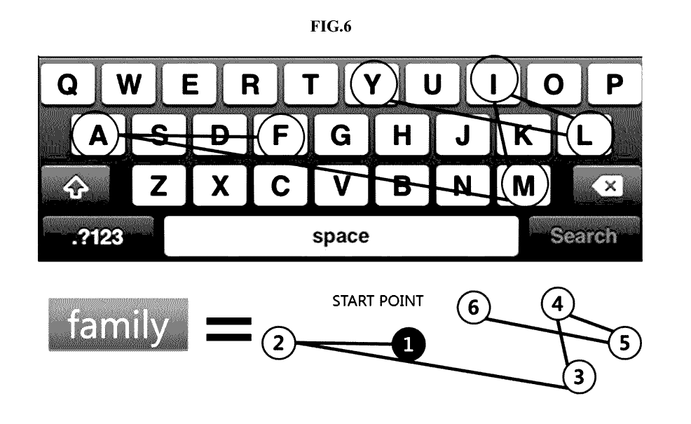

FIG. 6 is an illustration for describing a method of sensing key input in the detector 106 according to an embodiment of the present invention. For example, movement of a user's eyes tracked on a virtual keyboard as illustrated in an upper part of FIG. 6 is assumed to correspond to coordinates illustrated in a lower part of FIG. 6. In this case, except for 1 as a start point and 6 as an end point, folding occurs at four positions, i.e., positions 2, 3, 4, and 5. Accordingly, the detector 106 may sense, by sequentially connecting keys of the on-screen keyboard which correspond to a start point, folding occurrence positions, and an end point, that the user desires to input the word “family.” In this case, the detector 106 determines that keys corresponding to points, which a user's eyes has passed over and folding has not occurred, have not been intended to be typed. For example, in an embodiment illustrated in FIG. 5, the user's eyes sequentially pass D and S to move from F to A. However, since folding in a user eye movement path does not occur at positions corresponding to D and S, the detector 106 ignores input of keys located at the positions.

In another embodiment, the detector 106 calculates a movement speed of the user's eyes using the gaze points and may determine a key corresponding to coordinates, on which the calculated eye movement speed is a previously set value or less, as a letter or symbol which the user desires to input. For example, a position, when a movement speed of is fast on a user's eye movement route, may be considered as a case of moving between a key and a key, but a position, when the movement speed is slow, may be considered as a case of desiring to input a corresponding key. Accordingly, the detector 106 may be constituted to sense a movement speed of eyes and thus input a key corresponding to a position at which the eye movement speed is a set value or less.

In another embodiment, the eye tracker 104 may be constituted to sense blinking of the eyes of the user on the on-screen keyboard. In this case, the detector 106 may determine a key, which corresponds to coordinates at which a blink is sensed, as a letter or symbol which the user desires to input.

In another embodiment, the eye tracker 104 may sense a change in the sizes of the pupils, instead of blinking of the eyes of the user, on the on-screen keyboard, and the detector 106 may determine a key corresponding to coordinates, at which a change in the sizes of the pupils is a previously set degree or more, as a letter or symbol which the user desires to input. In general, human pupils have been known to expand when an interesting subject appears. When such a fact is applied, typing may be performed using the phenomenon that the pupils expand when a desired letter is found on a keyboard.

In the aforementioned embodiments, the folding degree, the change in an eye movement speed, the pupil size change amount, and the like may be suitably set by comprehensively considering physical features of a user, the size and layout of the on-screen keyboard on a screen, and the like. That is, it should be understood that embodiments of the present invention are not limited to a specific parameter range.

Next, the output unit 108 outputs a signal corresponding to the sensed letter or symbol. For example, the output unit 108 may be constituted to output ASCII or Unicode corresponding to the sensed letter or symbol.

Meanwhile, the eye tracking type input device 100 according to an embodiment of the present invention may further include the word recommendation unit 110, as described above.

In an embodiment, the word recommendation unit 110 is constituted to estimate a word, which the user desires to input, from letters or symbols sensed by the detector 106 and display the estimated word as a recommendation word through the image output means.

The word recommendation unit 110 may include a word list corresponding to language which a user desires to input. Accordingly, when a user inputs a specific letter string, the word recommendation unit 110 may compare the letter string to a stored word list and may display one or more words, which are selected according to ranking of similarity obtained by the comparison, as recommendation words on a screen. Accordingly, the user may complete typing of a corresponding word, without inputting all remaining alphabet letters, by moving eyes to a desired word among the recommendation words.

In addition, the word recommendation unit 110 may estimate a word, which the user desires to input, in consideration of letters or symbols sensed by the detector 106 along with letters or symbols closely arranged on the on-screen keyboard. For example, when a letter sensed by the detector 106 is “a,” the word recommendation unit 110 may estimate a word, which the user desires to input, in consideration of q, s, z, and the like located near “a” on a QWERTY keyboard. In this case, even when input through a user's eyes is somewhat inaccurate, a recommendation word may be effectively provided.

In another embodiment, the word recommendation unit 110 is constituted to estimate a word, which the user desires to input, from gaze points calculated by the eye tracker 104 and display the estimated word as a recommendation word through the image output means. In particular, the word recommendation unit 110 may compare a user's eye movement route calculated from gaze points calculated by the eye tracker 104 with a standard eye movement route for each of words and display one or more words as recommendation words on a screen according to route similarity obtained by the comparison.

In this case, the word recommendation unit 110 may include a word list that includes a plurality of words and a standard eye movement route for each of the words. Here, the standard eye movement route refers to a route along which a user's eyes should move to input each word. The standard eye movement route may be previously set for each of the words or may be dynamically constructed according to word input by a user. For example, when a user repeatedly inputs the same word, the standard eye movement route may be an average value of eye movement routes which are obtained by repeatedly inputting the same word.

When typing is performed by eye gazing, it is inevitable that speed and accuracy are relatively decreased, compared to typing by means of a general keyboard. Accordingly, loss of typing speed and accuracy may be compensated for by using the aforementioned word recommendation. With regard to a similarity calculation algorithm between an input letter string and a word list and the like, various means are known in the art to which the present invention pertains, and thus, detailed descriptions thereof are omitted.

Meanwhile, embodiments of the present invention may include programs for performing the methods disclosed in the specification on a computer and a computer-readable recording medium including the programs. The computer-readable recording medium can store program commands, local data files, local data structures or combinations thereof. The medium may be one which is specially designed and configured for the present invention or be one commonly used in the field of computer software. Examples of a computer readable recording medium include magnetic media such as hard disks, floppy disks and magnetic tapes, optical recording media such as CD-ROMs and DVDs, and hardware devices such as ROMs, RAMs and flash memories, which are specially configured to store and execute program commands. Examples of the programs may include a machine language code created by a compiler and a high-level language code executable by a computer using an interpreter and the like.

The exemplary embodiments of the present invention have been described in detail above. However, those skilled in the art will appreciate that various modifications, additions and substitutions are possible, without departing from the scope and spirit of the invention. Therefore, it should be understood that there is no intent to limit the invention to the embodiments disclosed, rather, the invention is to cover all modifications, equivalents, and alternatives falling within the spirit and scope of the invention as defined by the claims

What is claimed is:

1. An input device using eye-tracking, comprising:
a displayer configured to display an on-screen keyboard, on which a plurality of keys corresponding to inputtable letters or symbols are arranged, through an image output means;
an eye tracker configured to calculate gaze points on the on-screen keyboard according to a user's eyes;
a detector configured to detect letters or symbols, which the user desires to input, according to the calculated gaze points; and
a word recommender configured to store a word list that includes a plurality of words and a standard eye movement route for each of the words, compare a user's eye movement route calculated from the gaze points calculated by the eye tracker to the word standard eye movement route, and display one or more words as recommendation words on a screen according to route similarity obtained by the comparison,
wherein the displayer modifies size and arrangement of the keys of the letters or the symbols according to the use frequency each of the letter or the symbol.

2. The input device according to claim 1, wherein the displayer arranges the keys in the on-screen keyboard such that, with increasing use frequency of each of the letters or the symbols, a size of a key corresponding to the letter or the symbol increases.

3. The input device according to claim 1, wherein the displayer arranges the keys in the on-screen keyboard such that, with increasing use frequency of each of the letters or the symbols, a key corresponding to the letter or the symbol is arranged nearer to a middle of a screen of the image output means.

4. The input device according to claim 1, wherein the on-screen keyboard comprises a key for repeatedly inputting a letter or symbol that was input immediately beforehand.

5. The input device according to claim 1, wherein the eye tracker repeatedly calculates gaze points of the user according to a previously set period.

6. The input device according to claim 1, wherein the detector constructs an eye movement route of the user using the gaze points and, when a fold having a previously set angle or more is present on the eye movement route, determines a key, which corresponds to coordinates at which the fold occurs, as a letter or symbol which the user desires to input.

7. The input device according to claim 1, wherein the detector calculates a movement speed of the user's eyes using the gaze points and determines a key, which corresponds to coordinates at which the calculated eye movement speed is a previously set value or less, as a letter or symbol which the user desires to input.

8. The input device according to claim 1, wherein the eye tracker detects blinking of the user's eyes on the on-screen keyboard and the detector determines a key, which corresponds to coordinates at which a blink is detected, as a letter or symbol which the user desires to input.

9. The input device according to claim 1, wherein the eye tracker detects a change in sizes of the user's pupils on the on-screen keyboard and the detector determines a key, which corresponds to coordinates at which the change in the sizes of the pupils is a previously set degree or more, as a letter or symbol which the user desires to input.

10. The input device according to claim 1, further comprising a word recommender which estimates a word, which the user desires to input, from letters or symbols detected by the detector and displays the estimated word as a recommendation word through the image output means.

11. The input device according to claim 10, wherein the word recommender compares the letters or symbols detected by the detector to a stored word list and displays one or more words selected according to ranking of similarity obtained by the comparison as recommendation words.

12. The input device according to claim 11, wherein the word recommender estimates a word, which the user desires to input, in consideration of letters or symbols detected by the detector along with letters or symbols closely arranged on the on-screen keyboard.
